(19) United States
(12) Patent Application Publication
(10) Pub. No.: US 2011/0228522 A1
(43) Pub. Date: Sep. 22, 2011

(54) DECORATIVE LIGHT EMITTING APPARATUS, A REFLECTOR, AND A METHOD OF REFLECTING LIGHT

(75) Inventor: Huang MENG-SUEN, Hong Kong (CN)

(73) Assignee: MR. CHRISTMAS INCORPORATED, New York, NY (US)

(21) Appl. No.: 12/727,735

(22) Filed: Mar. 19, 2010

(51) Int. Cl. F21L 4/02; F21V 7/00; F21S 4/00

(52) U.S. Cl. 362/184; 362/296.01; 362/249.06

(57) ABSTRACT

This invention relates to a decorative light emitting apparatus, a reflector, and method of reflecting light. The decorative light emitting apparatus includes a light source attached to a supporting member and is configured to radiate light inwardly towards a reflector. The light then reflects off the reflector outwardly towards a viewer. The reflector is configured to produce a desired optical effect.

### FIELD OF INVENTION

The present invention relates to a decorative light emitting apparatus, a reflector, and a method of reflecting light. The decorative light emitting apparatus is designed so that light radiates inwardly from a light source towards a reflector, and reflects from the reflector outwardly towards a viewer. The reflector is configured to produce a desired optical effect.

### BACKGROUND OF THE INVENTION

It is common for people to display ornaments to celebrate holidays or other occasions. A conventional type of ornament is a light emitting ornament. Often, light emitting ornaments are placed on or hung from homes, trees, stoves, and the like.

Incandescent bulbs are often used as a light source in light emitting ornaments. However, several problems arise when using incandescent bulbs. First, incandescent bulbs draw a substantial amount of power. Therefore, over long periods of time incandescent bulbs are costly to operate. Second, incandescent bulbs are inefficient light emitters, because most of the energy supplied to an incandescent bulb is converted into heat, rather than light. To compensate, higher wattage bulbs which draw more power are commonly used to achieve the desired luminosity. However, using higher wattage bulbs not only increases the operating costs, but also increases the amount of heat produced. Therefore, a substantial risk of fire is associated with using higher wattage incandescent bulbs. This risk is compounded by the fact that light emitting ornaments are often attached to combustible materials, such as Christmas trees. Third, a typical ornament may use several light emitters, further exacerbating the problems discussed above. Fourth, incandescent bulbs are generally large, and because of their inefficient light production require comparatively large power sources. As a result, light emitting ornaments which use incandescent bulbs tend to be relatively heavy.

More recently, light emitting diodes (LEDs) have been used in festive lighting arrays, in conventional manners. While LEDs alleviate some problems associated with incandescent bulbs, there is still room for improvement in this regard. Therefore, there is still a need for a decorative light emitting device capable of producing high luminosity while drawing a small amount of power, producing little heat, and being light-weight.

### SUMMARY OF THE INVENTION

Accordingly, one object of the present invention is to provide a decorative light emitting apparatus which produces high luminosity while drawing a small amount of power using minimal equipment. One embodiment of the present invention provides a decorative light emitting apparatus that includes a reflector configured to form a plurality of reflective cavities, a supporting member connected to the reflector, and an LED light source, at least a portion of which is connected to the supporting member. The LED light source radiates light inwardly towards the reflector to provide a light display for a viewer. Preferably, each reflective cavity is formed by two reflective surfaces which are angled towards each other along an axis which extends radially from a center point common to the plurality of cavities. A viewing axis is defined by the LED light source and the center point.

The LED light source may include a plurality of LEDs each of which emanates light of a different color. Preferably, the apparatus also includes a controller for controlling the LED light source to emanate light of different colors at predetermined intervals. Also included is a power source such as a battery.

As discussed, in a preferred embodiment, the reflector is configured to form a plurality of reflective cavities, with each reflective cavity being formed by two reflective surfaces angled towards each other along an axis which extends radially from a center point common the plurality of reflective cavities. Of course, additional reflective surfaces may be provided in the cavities. Also, the center point should be understood as defining a position substantially about which (fully or partially) the cavities are arranged.

The reflective surfaces are disposed so that light directed thereon from an LED light source is reflected towards a viewer positioned substantially along a viewing axis. It should be noted that the reflective surfaces may be disposed so as to reflect light in parallel, along the viewing axis, or converging to a point thereon. In a preferred embodiment, the viewing axis is defined as a line that intersects the LED light source and the center of the reflector, and is transverse to the reflective surface at the center of the reflector. The LED light source is disposed at a predetermined distance from the center of the reflector, which is less than the maximum depth of the reflector. From that position, the LED light source projects light towards the reflector. With this configuration, a reflected image of the LED light source is formed on each of the reflective surfaces when viewed from a position substantially along the viewing axis.

The LED light source may comprise a reflective member for projecting the light toward the reflector. Thus, instead of the LED projecting light inwardly to the reflector, it is directed toward the reflecting member, which has a reflective surface for projecting the light toward the reflector. In this case, the reflective member is preferably positioned along the viewing axis, as described.

Still another object of the present invention is to provide a method for reflecting light using a decorative light emitting apparatus which includes a reflector having a plurality of reflective cavities, a supporting member connected to the reflector, and an LED light source connected to the supporting member. The method includes the step of positioning the LED light source at predetermined distance on a viewing axis relative to the center of the reflector where the predetermined distance is less than a maximum depth of the reflector. Light is then radiated from the LED light source inwardly so that a reflective image of the LED light source is formed on the reflective surfaces of each reflective cavity when viewed from a position substantially along the viewing axis. As above, in a preferred embodiment the viewing axis is defined by the position of the LED light source and the center of the reflector, and is transverse to the reflective surface at the center of the reflector.

These and other objects, features, and advantages of the present invention will be apparent from the following description of the preferred embodiments, with reference to the following drawings.

### BRIEF DESCRIPTION OF THE DRAWINGS

FIG. 1A is a vertical cross section, taken along a line L₁ in FIG. 1B, of the decorative light emitting apparatus according to the first embodiment of the present invention.

FIG. 1B is a plan view of the decorative light emitting apparatus according to the first embodiment of the present invention.

FIG. 2 is perspective view of a cross section, taken along the line L₂ as shown in FIG. 1B, of the decorative light emitting apparatus according to the first embodiment of the present invention.

FIG. 3 is a frontal view of the decorative light emitting apparatus according to the first embodiment of the present invention from a position along the viewing axis.

FIGS. 4A and 4B are side perspective views of the decorative light emitting apparatus according to the first embodiment of the present invention, showing the supporting member retracted from and engaged to the rear of the reflector.

FIG. 5 is a frontal view of the decorative light emitting apparatus according to the second embodiment of the present invention.

FIG. 6 is a frontal view of the decorative light emitting apparatus according to the third embodiment of the present invention.

### DETAILED DESCRIPTION OF THE INVENTION

General Features

The present invention relates to a decorative light emitting apparatus and a reflector therefor. The decorative light emitting apparatus is designed so that light radiates inwardly from a light source towards a reflector, and reflects from the reflector outwardly towards a viewer. A decorative light emitting apparatus of this type preferably includes, among other features, a light source, a supporting member on which the light source is mounted or attached, and a reflector.

In the preferred embodiments, LEDs are used as a light source. Depending upon the display, the LED light source can be of various sizes, shapes, colors, and quantity. For example, one of the features of the present invention is to supply the LED light source with several LEDs, each producing a different color. Preferably, three LEDs of three different colors are used. While LEDs are preferred due to their compact size and high efficiency, the present invention is not limited to their use. Other types of light sources could be used, for example, high efficiency compact fluorescent bulbs may be used.

Another beneficial feature of the present invention is a controller for controlling the LED light source. The controller controls which LEDs are activated, when the LEDs are activated, and for how long. The controller can activate the LEDs in a prescribed or random pattern to produce a desired optical effect. In addition, the number of LEDs activated simultaneously could vary to change the amount of light and/or optical effect put out by the decorative light emitting apparatus. Depending on the desired optical effect, more than one LED could be activated to produce multiple colors. The controller may be either hardwired or configurable by the user.

In the present invention the LED light source is configured to radiate light inwardly towards the reflector, although it may also radiate light outwardly. By radiating light inwardly towards the reflector, the present invention takes advantage of the geometric configuration of the reflector, and the surface characteristics of the reflector, to produce a desired optical effect. By configuring the reflector to form a certain geometric pattern, light emanating from the LED light source can be reflected in a predetermined direction, thereby producing a specific optical pattern based on the geometry of the reflector. In addition, the surface properties of the reflector can be configured in accordance with the desired reflective pattern. For example, a smooth surface with high reflectance will reflect light in accordance with the angle of incidence with respect to the surface. However, a non-smooth surface will cause incoming light to disperse in multiple directions. Therefore, by altering the surface characteristics and geometry of the reflector, light emanating inwardly from the LED light source can be reflected to form a desired pattern.

In the present invention, the reflector is composed of several reflective cavities. Each reflective cavity is formed by two or more reflective surfaces. As discussed above, in a preferred embodiment the reflective surfaces are oriented to reflect light from the LED light source outwardly towards a viewer. While, in the preferred embodiment, the reflector is configured to form a star shape, the present invention is not limited as such. Numerous other ornamental patterns could be formed from a plurality of reflective cavities.

In order to radiate light inwardly towards the reflector a supporting member is provided to position the LED light source spaced away from, and oriented towards, the reflector. When a reflective member is provided the LEDs are oriented away from the reflector and towards the reflective member, which in turn reflects the light inwardly. Furthermore, the LED light source is positioned a predetermined distance from the base of the reflector, which is less than the maximum depth of the reflector. In a preferred embodiment, the LED light source and a center point of the reflector define a viewing axis. It should be noted that the center point may be a point common to the plurality of cavities. Depending upon how the supporting member is attached to the reflector, the center point may also be the center of the supporting member itself.

It will be appreciated by one of ordinary skill in the art, that the supporting member can be of many different forms. For example, the supporting member may be a single object attached to the reflector, or may be multiple wires configured to provide opposite retaining forces to secure the light source in place. In addition, the supporting member may be transparent so as not to obstruct the formation of a reflective image.

One of the benefits of the present invention is that an image of the LED light source is visible on each of the reflective surfaces when viewed from a position lying substantially on the viewing axis. This allow for one or more LEDs, along with the reflective surfaces, to provide the perceived effect of an entire array of lights, without the weight or energy requirement of a light array. As one of ordinary skill in the art will appreciate, for a given distance from the reflector along the viewing axis, there is a corresponding range about the viewing axis from which reflected images of the LED light source are visible. This viewing range decreases with distance from the reflector.

In addition, a hole is provided at the distal end of at least one of the plurality of reflective cavities, relative to a center point common to the plurality of reflective cavities, so that the decorative light emitting apparatus can be secured to another object, for example a Christmas tree. Furthermore, the decorative light emitting apparatus may also include a capping member attached to the rear of the reflector which holds a control board and power source. The capping member may also provide means for attaching the decorative light emitting apparatus to another object, such as a Christmas tree.

The above described features, aspects, and advantages of the present invention will now be described in relation to specific embodiments.

### First Embodiment

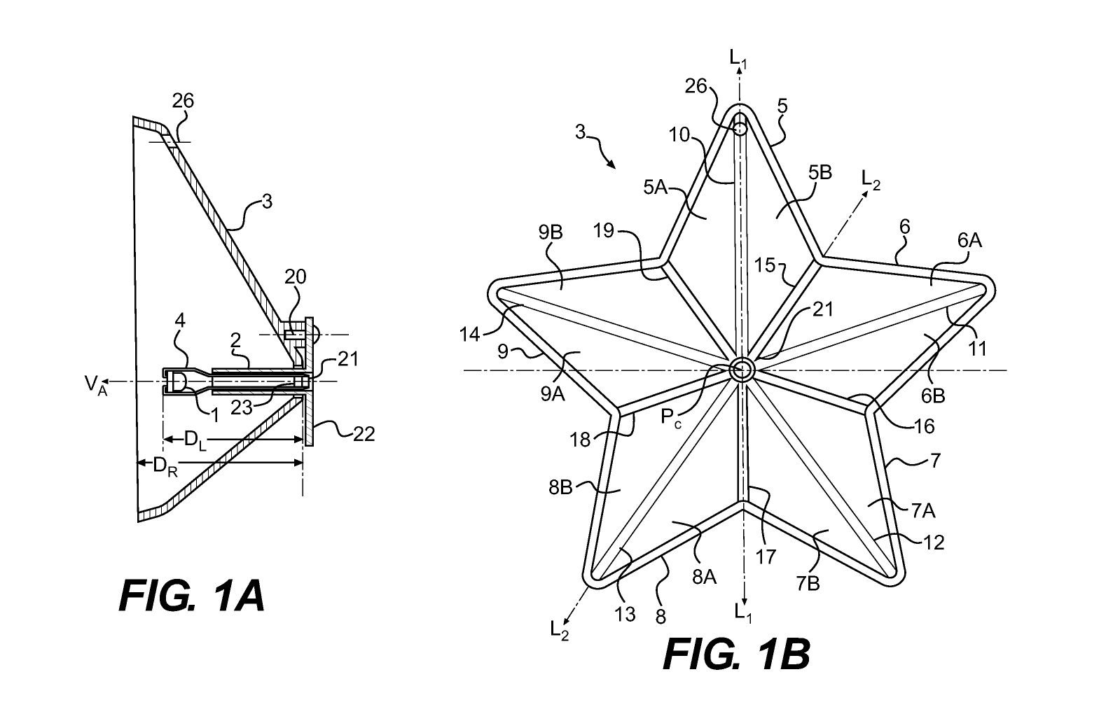

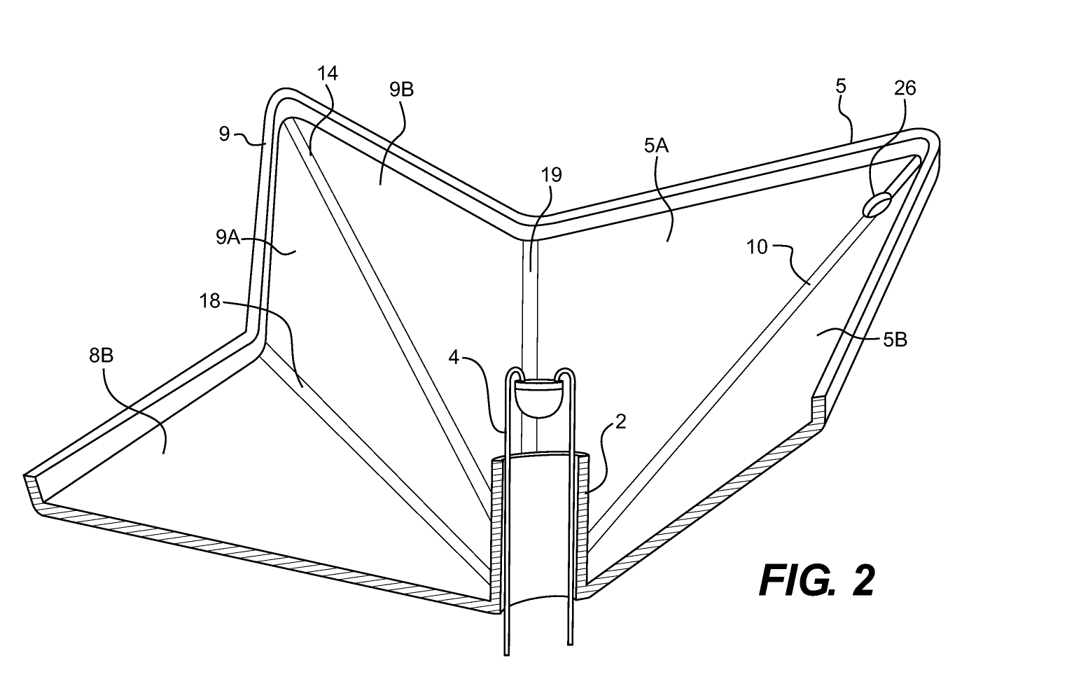

As shown in FIGS. 1A and 1B a decorative light emitting apparatus according to the first embodiment of the present invention includes a light source 1 which is connected to a supporting member 2, which in turn is connected to a reflector 3.

As shown in FIG. 1A, the LED light source 1 is oriented so as to emanate light inwardly towards the reflector 3. The LED light source 1 includes LED lead wires 4 which are positioned inside the cylindrical cavity of the supporting member 2. The LED light source 1 is supported by the LED lead wires 4, which are secured to the LED light source 1 on a side opposite the side facing the reflector 3. The lead wires 4 may also be aligned with an axis dividing the surface of two reflective cavities. One of the beneficial features of running the lead wires 4 through the interior of the supporting member 2, is that the supporting member 2 exerts a frictional force on the lead wires 4. Because the lead wires 4 are bent, a spring like force is exerted in on the supporting member 2, in a direction orthogonal to the surface thereof. Thus, movement of the LED lead wires 4 parallel to the interior surface of the supporting member 2 is resisted by a frictional force proportional to the spring like force. In this embodiment, the LED light source 1 can be composed of a single LED or multiple LEDs, either of the same color or different colors. As discussed above, a controller (not shown) may also be provided to control the LED light source 1.

As shown in FIG. 1B, the reflector 3 is configured to form a plurality of reflective cavities 5-9, reflective surfaces 5A-9B, radial axes 10-14, and splines 15-19. Each reflective cavity is formed by two reflective surfaces, which are angled towards each other along a radial axis, extending from a center point P_{c} common to the plurality of cavities. For example, reflective surfaces 5A and 5B are angled towards each other along a radial axis 10. In this embodiment, each reflective cavity forms a star point, centered along a respective radial axis. Thus, the points of each star are defined by the distal ends of the radial axes. Each reflective cavity adjoins another reflective cavity along a spline, which also lies in the radial direction. For example, reflective cavities 5 and 6 adjoin each other along spline 15. The distal end of each spline is an indentation point in the star shape, denoting a boundary between each reflective cavity between each star point.

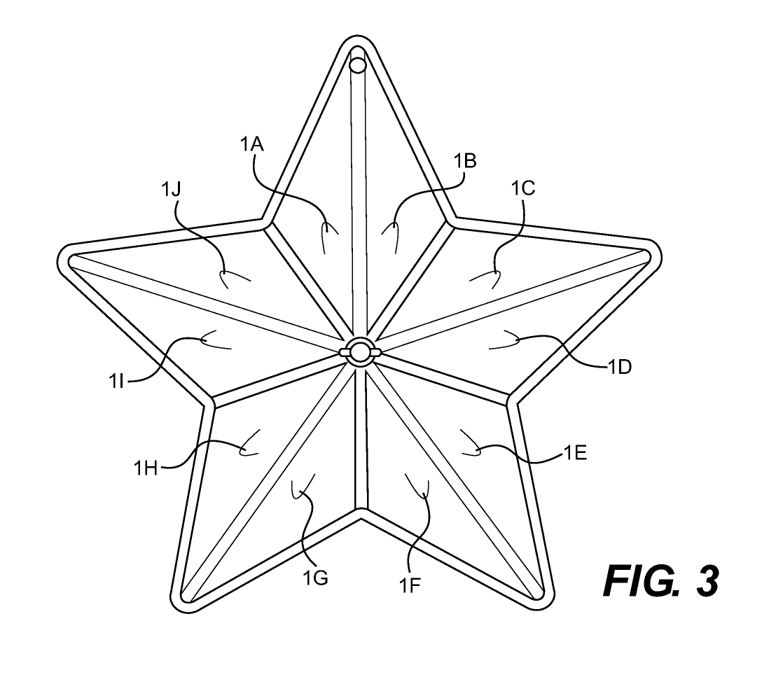

FIG. 2. is a cross-sectional view of the decorative light emitting apparatus according to the first embodiment, taken along the line L₁ in FIG. 1B. In FIG. 1B, a two-dimensional projection of each reflective cavity defines a general diamond-like shape. However, as can be seen in FIG. 2 each reflective cavity in three dimensions forms a pyramidal structure.

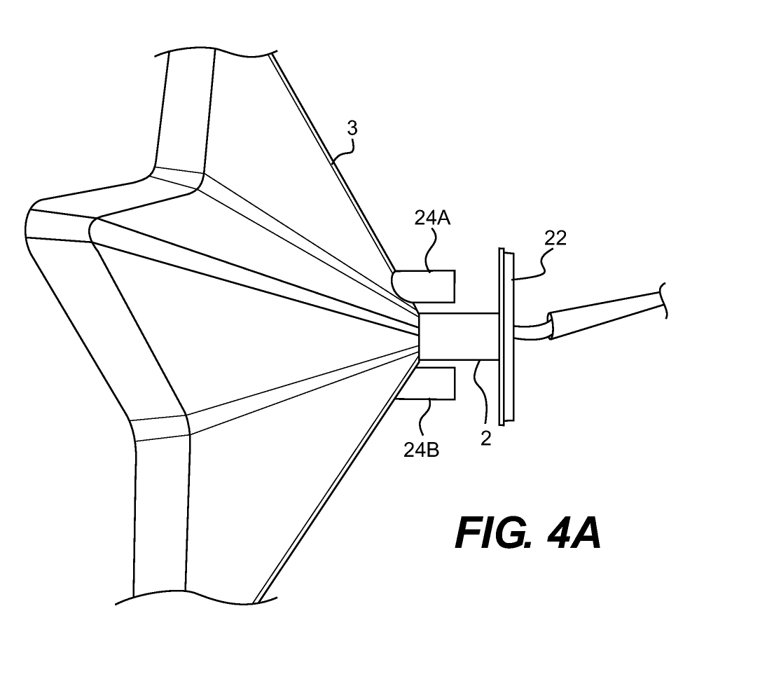

As discussed, one of the advantages of the present invention is that the reflector 3 can be formed so that the reflective surfaces 5A-9B are oriented in specific positions, to produce a desired optical effect. FIG. 3 is a view of the decorative light emitting apparatus according to the first embodiment, along the viewing axis Vₐ. The viewing axis Vₐ is defined by the LED light source 1 and the center point P_{c}, showing a specific optical effect. In addition, in this embodiment the supporting member 2 is aligned with the viewing axis Vₐ. In FIG. 3, the reflective surfaces 5A-9B are oriented to reflect light from the LED light source 1 in such a manner that reflected images 1A-1J of the LED light source 1 are visible on the reflective surfaces 5A-9B, when the decorative light emitting apparatus is viewed from a position substantially along the viewing axis Vₐ. It should be noted that the optical effect is visible within a viewing range about the viewing axis Vₐ, the precise dimensions of which vary in accordance with distance from the decorative light emitting apparatus. By arranging the reflective surfaces 5A-9B in such a manner it is possible with a single LED light source 1, or single LED, to illuminate each reflective cavity, or in other words, each point of the star.

When multiple LEDs are activated in the LED light source 1, the viewer sees reflected images of the light source, including a composition of the individual colors of each LED that is activated. By combining the light of different color LEDs, the present invention provides the additional benefit of being able to produce a broad spectrum of colors with relatively few LEDs. Such a feature is advantageous because fewer LEDs are required to produce a desired optical effect. This combined with the ability of the reflecting surfaces multiplying the number of light sources perceived by a viewer allow for the perception of an array of lights and colors, without the number of lights required in a conventional device.

In addition to arranging the reflective surfaces 5A-9B in a particular orientation to produce a desired optical effect, the surface of the reflector 3 can also be modified to alter the optical effect. For instance, when the surface of the reflector 3 is smooth and highly reflective, (as in FIG. 3) light incident on the surface reflects from the surface in accordance with the angle of incidence, this type of reflection is known as specular reflection. However, when the surface of the reflector 3 is uneven, the light incident on the surface is reflected in multiple different directions, thereby producing diffuse reflection. Accordingly, by modifying the surface properties of the reflector 3 to produce specular or diffuse reflection, or a combination thereof, a desired optical effect can be achieved.

To produce a surface with a high reflectance for specular reflection, the surface may be coated with reflective layer. One example is a metallized surface, i.e. where a metal coating is provided. To produce an uneven surface for diffuse reflection, the surface maybe unevenly coated with a reflective material, or may be physically roughened. As one of ordinary skill in the art will appreciate, the above mentioned methods of altering the surface properties of the reflector are just a few examples of many possible ways to achieve the desired result.

As shown in FIGS. 1A and 1B the reflector 3 also includes a hole 21 for the supporting member 2 to protrude through. A base portion 22 of the supporting member 2 engages the rear of the reflector 3, and a fastener is placed through a hole in the base portion 22 of the supporting member 2, into a slot 20 on the rear of the reflector 2, so as to secure the supporting member 2 to the reflector 3. In addition, to even more securely attach the supporting member 2 to the reflector 3, one or more additional slots could be provided on the rear of the reflector 3, as well as an additional number of corresponding holes in the base portion 22 of the supporting member, for additional fasteners. As shown in FIG. 1A the supporting member 2 is disposed so that a distance D_{L} from the base 23 of the reflector 3 to the LED light source 1 is less that the maximum depth D_{R} of the reflector 3.

In an alternate arrangement, the LEDs are arranged closer to or at the center point, and the LED light source further includes a reflective member provided along the viewing axis to reflect light directed out from the LEDs back to the reflective surfaces. In this arrangement the reflective member and the LEDs may both be attached to the same supporting member, or to different supporting members, of the same type or different types. This arrangement achieves a similar effect as the other embodiments inasmuch as the LED light source projects light from a position spaced away from the reflector to the reflective surfaces.

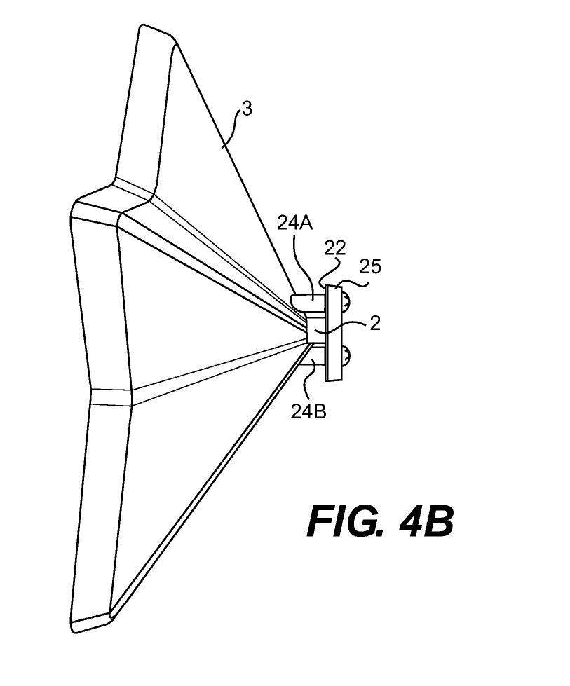

FIGS. 4A-4B are side views of the decorative light emitting apparatus according to the first embodiment, showing an alternate configuration for securing the supporting member 2 to the reflector 3. As shown in FIG. 4A, the supporting member 2 may be secured to reflector 3 by sliding the base portion 22 of the supporting member 2 over two mounting projections 24A and 24B extending from the rear of the reflector 3. As shown in FIG. 4B, a capping member 25 is then placed over the supporting member 2, and fasteners are used to join the reflector 3, the supporting member 2, and the capping member 25 together.

In this configuration, a small space is provided between the supporting member 2 and the capping member 25 in which a control board may be placed, along with a power source, such as a battery. In addition, the capping member 25 may be configured to provide attachment means for attaching the decorative light emitting apparatus to a pole, or a tree. Furthermore, as shown in FIGS. 1A and 1B, a passage 26 is also provided at the distal end of at least one of the reflective cavities to provide an additional means for mounting the decorative light emitting apparatus to another object.

As previously mentioned, by supplying the lead wires 4 through the interior of the cylindrical supporting member 2, a frictional force between the lead wires 4 and supporting member 2 resists motion in a direction parallel to the surface of the cylindrical supporting member 2. Therefore, even if the lead wires 4 are only soldered to a control board the added frictional force imparts additionally resiliency to the apparatus, thereby overcoming the generally weak mechanical strength of solder.

As discussed above, one of ordinary skill in the art will appreciate that the location of the supporting member 2 may be varied in order to accommodate various geometric designs for the reflector 3. Furthermore, it is possible to connect the supporting member 2 to any position along the reflector 3 or, in the alternative, to use wires to suspend the LED light source 1. Nevertheless, ideally the position of the supporting member 2 does not obscure the formation of reflected images on the reflective surfaces. Positioning the supporting member 2 in a location where a reflected image of the LED light source 1 is not formed on a portion of the reflector, decreases the amount of the light reflected outwardly towards the viewer, and potentially disrupts the desired the optical effect.

### Second Embodiment

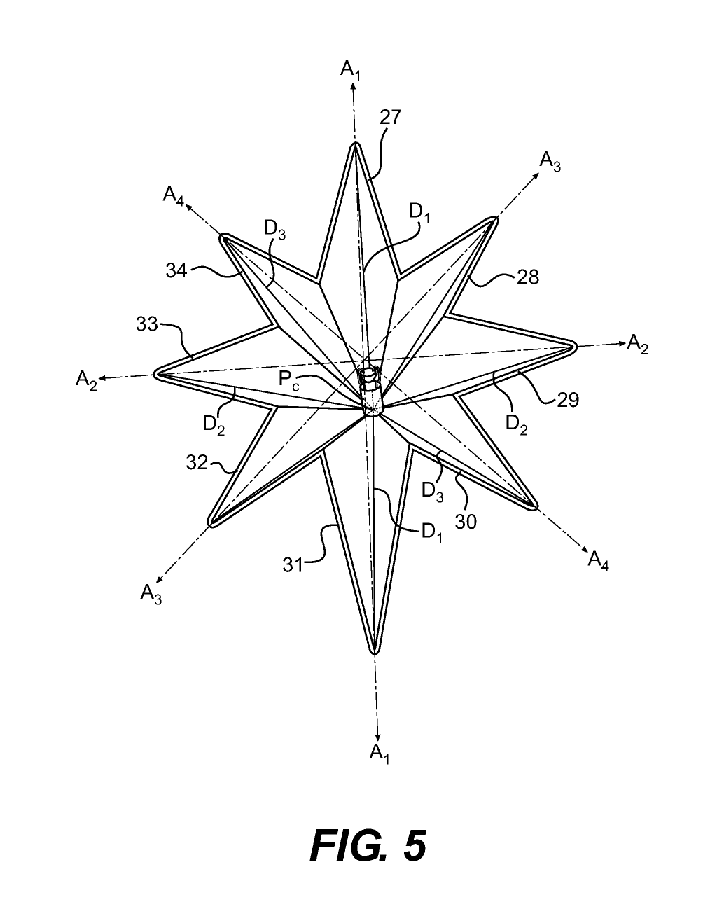

FIG. 5 shows a decorative light emitting apparatus according to the second embodiment of the present invention. The second embodiment shares in common several features of the first embodiment. Therefore, a discussion of those features is omitted.

In this embodiment, eight reflective cavities 27-34 are provided. However, as shown in FIG. 5, the sizes of the reflective cavities are not equal. The reflective cavities can be sorted into three groups according to size. Reflective cavities 27 and 31 are disposed along an axis A₁ and have the largest volume. A distance D₁ from a point common to the plurality of reflective cavities P_{c} to a distal point of either reflective cavity 27 or 31, is greater than a corresponding distance for the other reflective cavities. Reflective cavities 29 and 33 are disposed along an axis A₂, orthogonal to axis A₁, and have an intermediate volume. A distance D₂ from the common point P_{c} to the distal point of either reflective cavity 29 or 33, is an intermediate distance. Reflective cavities 28 and 32 are disposed along an axis A₃, and reflective cavities 30 and 34 are disposed along an axis A₄. Reflective cavities 28, 30, 32, and 34 have the smallest volume. Both axes A₃ and A₄ are set forty-five degrees from axes A₁ and A₂. A distance D₃ from the common point P_{c} to the distal point of either reflective cavity 28, 30, 32, or 34 is smaller than either D₁ or D₂. Because each group of reflective cavities have different volumes, the orientation of the reflective surfaces in each group is also different.

### Third Embodiment

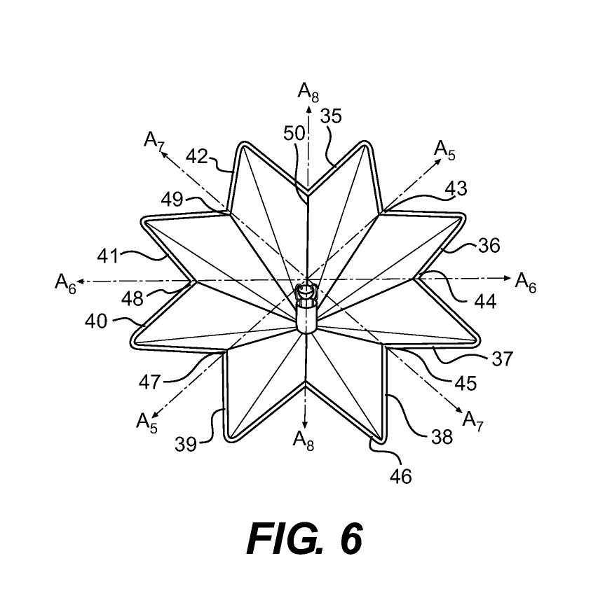

FIG. 6 shows a decorative light emitting apparatus according to the third embodiment of the present invention. The third embodiment shares several features with the first embodiment. Accordingly, a discussion of those common features is omitted.

In this embodiment, eight reflective cavities 35-42 are provided. However, in contrast to the second embodiment, each reflective cavity has the same size. As can be seen in FIG. 6, a plurality of splines 43-50, separate adjacent reflective cavities, and are disposed along axes A₅-A₈. For example, spline 43 marks a boundary between reflective cavities 35 and 36, and lies on axis A₅. Because the size of the each of the reflective cavities is the same, the orientation of the reflective surfaces are the same for each of the reflective cavities.

Accordingly, while the present invention has been described with reference to certain preferred embodiments, it is to be understood that this description and accompanying drawings are not intended to limit the scope of the following claims.

What is claimed is:

1. A decorative light emitting apparatus, comprising:
a reflector configured to form a plurality of reflective cavities;
a supporting member connected to said reflector; and
an LED light source, where at least a portion of said LED light source is connected to said supporting member and configured to radiate light inwardly towards said reflector,
wherein each reflective cavity is formed by two reflective surfaces angled towards each other along an axis which extends radially from a center point common to the plurality of cavities, and wherein said LED light source and the center point define a viewing axis.

2. A decorative light emitting apparatus as recited in claim 1, wherein said LED light source comprises a reflective member for radiating light inwardly.

3. A decorative light emitting apparatus as recited in claim 2, wherein the reflective member is supported by said supporting member.

4. A decorative light emitting apparatus as recited in claim 1, wherein said supporting member extends along the viewing axis.

5. A decorative light emitting apparatus as recited in claim 4, wherein the reflective surfaces of each cavity are disposed so as to reflect light from said LED light source substantially in the direction of the viewing axis.

6. A decorative light emitting apparatus as recited in claim 5, wherein the reflective surfaces of each cavity are positioned to reflect light from said LED light source such that a reflected image of said LED light source is visible on each of the reflective surfaces of each cavity when the decorative light emitting apparatus is viewed from a position substantially along the viewing axis.

7. A decorative light emitting apparatus as recited in claim 1, wherein the surface of said reflector is a metallized surface.

8. A decorative light emitting apparatus as recited in claim 1, wherein the surface of said reflector is coated with a reflective material.

9. A decorative light emitting apparatus as recited in claim 1, wherein an opening is provided in said reflector, at the distal end of at least one of the plurality of reflective cavities, relative to the center point common to the plurality of cavities.

10. A decorative light emitting apparatus as recited in claim 1, wherein said LED light source includes of a plurality of LEDs and each LED emanates light of a different color.

11. A decorative light emitting apparatus as recited in claim 10, further comprising:
a controller for controlling said LED light source to emanate light of various colors at predetermined intervals.

12. A decorative light emitting apparatus as recited in claim 1, wherein said supporting member is cylindrical in shape and configured to receive electrical contacts, attached to said LED light source, in the interior of said supporting member.

13. A decorative light emitting apparatus as recited in claim 1, wherein a distance between said LED light source and a point where said reflector connects to said supporting member is less than a maximum depth of said reflector.

14. A decorative light emitting apparatus as recited in claim 1, further comprising:
a power source for said LED light source, wherein said power source is a battery.

15. A decorative light emitting apparatus as recited in claim 1, further comprising:
a pair of wires that suspend at least a portion of said LED light source, said wires providing power to said LED light source.

16. A method for reflecting light using a decorative light emitting apparatus, comprising:
providing a reflector configured to have a plurality of reflective cavities, a supporting member connected to the reflector, and an LED light source, where at least a portion of the LED light source is connected to the supporting member;
positioning at least a portion of the LED light source at a predetermined distance along on a viewing axis, relative to a center point of the reflector, where the predetermined distance is less than a maximum depth of the reflector, and
radiating light from the LED light source inwardly towards the reflector so that a reflective image of the LED light source is formed on each of the reflective surfaces of each reflective cavity when viewed substantially along the viewing axis at a distance greater than the predetermined distance, and
wherein the viewing axis is defined by at least a portion of the LED light source and the center point.

17. A method for reflecting light using a decorative light emitting apparatus, as recited in claim 16, wherein the LED light source comprises a reflective member for radiating light inwardly toward the reflector.

18. A method for reflecting light using a decorative light emitting apparatus, as recited in claim 16, wherein the mirror is supported by the supporting member.
